(19) United States
(12) Patent Application Publication
(10) Pub. No.: US 2024/0423159 A1
(43) Pub. Date: Dec. 26, 2024

(54) LIVESTOCK FEEDER

(71) Applicant: Jerry Strauss, Altha, FL (US)

(72) Inventor: Jerry Strauss, Altha, FL (US)

(21) Appl. No.: 18/212,312

(22) Filed: Jun. 21, 2023

(51) Int. Cl. A01K 5/02

(52) U.S. Cl. CPC A01K 5/0225

(57) ABSTRACT

A livestock feeder is disclosed, including a hopper including an interior to store feed. A base is removably coupled to a bottom of the hopper, the base comprising a plurality of apertures each opening to a port to dispense the feed via gravity. A mount is centrally positioned on the base to receive a post, the mount to raise the livestock feeder above the ground to provide an automated, gravity fed feeder which is resistant to tampering, damage, and unwanted access by opportunist animals.

### TECHNICAL FIELD

Embodiments of the invention relate to animal and livestock feeders and more particularly to deer feeders.

### BACKGROUND

Feeders are a piece of livestock equipment which include a feed holder. The feed holder may be a foxed holder (hopper) which delivers feed to the animal. The feed is often automatically dispensed using gravity, or more complex system which contain an auger. This allows the farmer to load feed into the hopper and ensure the livestock is fed repeatedly until the hopper needs to be refilled.

In the current arts, feeders include a hopper having a funnel positioned therein to direct the feed through a single hole. The funnel results in diminished hopper capacity. The hopper is held upright by multiple legs which can be easily broken by predatory or opportunist animals wanting to feed on the contents within the hopper. Further, the legs in the prior art devices can damage the velvet on a deer's antlers.

### SUMMARY OF THE INVENTION

This summary is provided to introduce a variety of concepts in a simplified form that is disclosed further in the detailed description of the embodiments. This summary is not intended for determining or limiting the scope of the claimed subject matter.

The embodiments provided herein relate to A livestock feeder is disclosed, including a hopper including an interior to store feed. A base is removably coupled to a bottom of the hopper, the base comprising a plurality of apertures each opening to a port to dispense the feed via gravity.

A mount is centrally positioned on the base to receive a post, the mount to raise the livestock feeder above the ground to provide an automated, gravity fed feeder which is resistant to tampering, damage, and unwanted access by opportunist animals.

In the prior art, gravity feeders include only a single port to dispense feed. These devices require three or more legs to raise and mount the feeder to the ground. This does not prevent tampering and unwanted access from animals and may damage the velvet on deer's antlers.

In one aspect, four ports are provided and are equally and radially spaced about the base.

In one aspect, each port includes a vertical portion and a curved portion to dispense food away from underneath the livestock feeder.

In one aspect, the base is coupled to the hopper via a fastener. The fastener extends through the base and through the interior of the hopper to releasably couple the base to the hopper.

In one aspect, the hopper is configured as a barrel. The barrel may be constructed of a resilient material such as steel.

In one aspect, the hopper is further comprised of a lid to enclose the interior of the hopper.

Other objects and advantages of the various embodiments of the present invention will become obvious and intuitive to the reader and it is intended that these objects and advantages are within the scope of the present invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the base, according to some embodiments;

FIG. 2 illustrates a perspective view of the bottom side of the feeder, according to some embodiments;

FIG. 3 illustrates a perspective view of the bottom side of the base of the feeder, according to some embodiments;

FIG. 4 illustrates a perspective view of the feeder, hopper, and egress ports, according to some embodiments;

FIG. 5 illustrates a perspective view of the bottom side of the feeder, according to some embodiments;

FIG. 6 illustrates a front elevation view of the livestock feeder mounted to a post, according to some embodiments;

FIG. 7 illustrates a front elevation view of the livestock feeder and livestock, according to some embodiments;

FIG. 8 illustrates a cutaway view of the interior of the hopper including the divider, according to some embodiments; and

FIG. 9 illustrates a perspective view of the bottom side of the livestock feeder, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, the term “livestock” may relate to domesticated, farmed, and/or wild animals which may benefit from the livestock feeder described herein. While the particular example of feeding deer using a deer feeder (i.e., the livestock feeder) may be used, one skilled in the arts will readily understand that the embodiments may be used for various forms of livestock.

As used herein, the term “feed” may be used to describe foodstuffs which is loaded into the hopper of the livestock feeder to feed the livestock. The feed may take various forms known in the arts.

In general, the embodiments provided here relate to a livestock feeder having a hopper and a plurality of ports to dispense feed therefrom. The feed is dispensed via gravity to provide automated feeding of the livestock to provide efficiency and convenience to personnel handling the livestock. The livestock feeder is mounted to a single beam extending from the center of the bottom base of the hopper to provide a secure, stable, and durable mount to the ground surface. The mount is tamperproof to make it difficult for predatory and/or opportunist animals to destroy, damage, or gain access to the livestock feeder.

FIG. 1 illustrates a perspective view of the base 100 which is mountable to the bottom side of the livestock feeder. The base 100 includes a plate 101 which may be configured as a circular base which encloses the bottom of the hopper. The base 100 includes a plurality of ports 103, 105, 107, 109 which allow for the egress of feed therethrough. The plate 101 has a plurality of apertures 111, 113, 115, 117 which each align with each port 103, 105, 107, 109 to allow the feed to travel from the interior of the hopper and into the ports 103, 105, 107, 109. The base 100 includes a fastener 119 extending along the central axis of the hopper to secure the base 100 to the hopper during use.

In some embodiments, the base 100 and apertures 111, 113, 115, 117 align with holes cut into the bottom of the hopper (i.e., the barrel). The holes in the bottom of the hopper allow for the alignment of the apertures 111, 113, 115, 117 provided on the base of the livestock feeder.

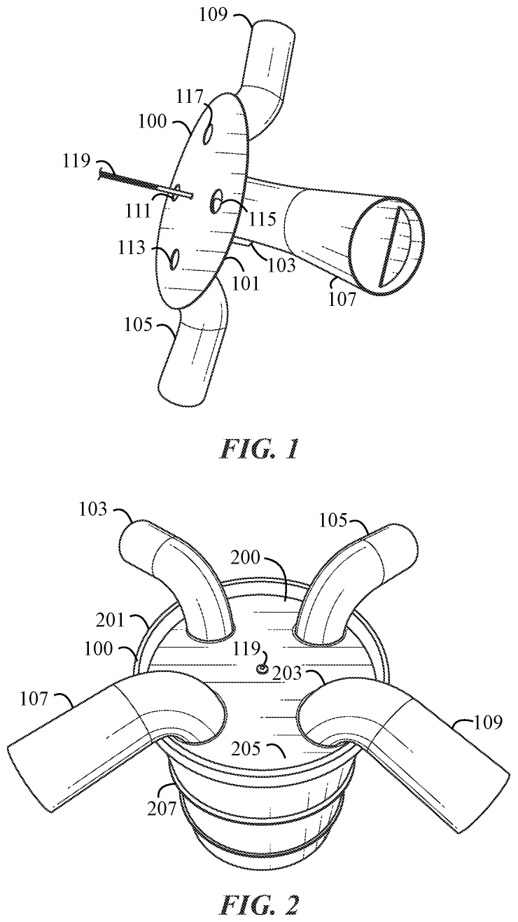

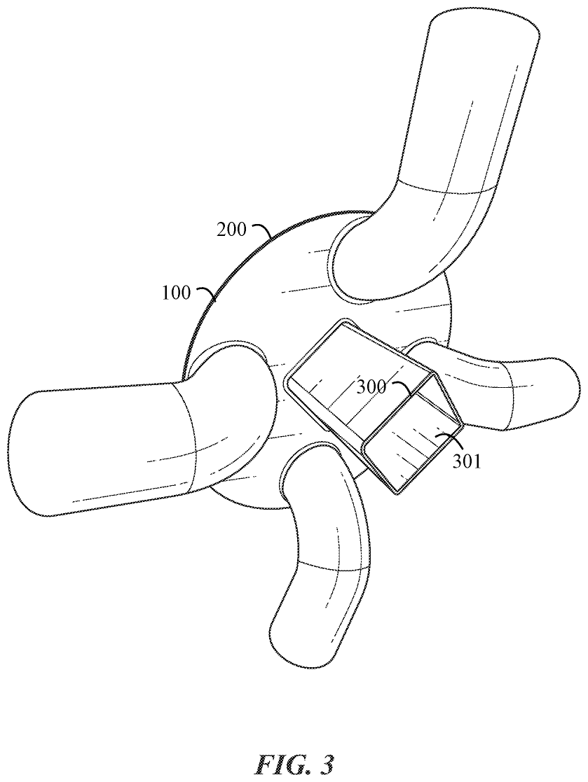

FIG. 2 illustrates a perspective view of the bottom side 200 of the livestock feeder 201. Each port 103, 105, 107, 109 is equally spaced radially about the base 100. The ports 103, 105, 107, 109 extend vertically in a first portion 203 and are angled to direct the feed away from the bottom side 200 of the base 100. The fastener 119 protrudes through the bottom surface 205 and extends through the interior of the hopper 207.

FIG. 3 illustrates a perspective view of the bottom side 200 of the base 100 of the feeder 201. A mount 300 protrudes from the bottom side 200 and is configured to receive a post which extends to the ground surface. The mount 300 is centrally positioned on the base 100 to provide a single mounting position, rather than multiple legs extending from the bottom as is seen in the prior art. The mount 300 includes an aperture 301 wherein the post is positioned and allow for easy mounting and dismounting of the livestock feeder from the post.

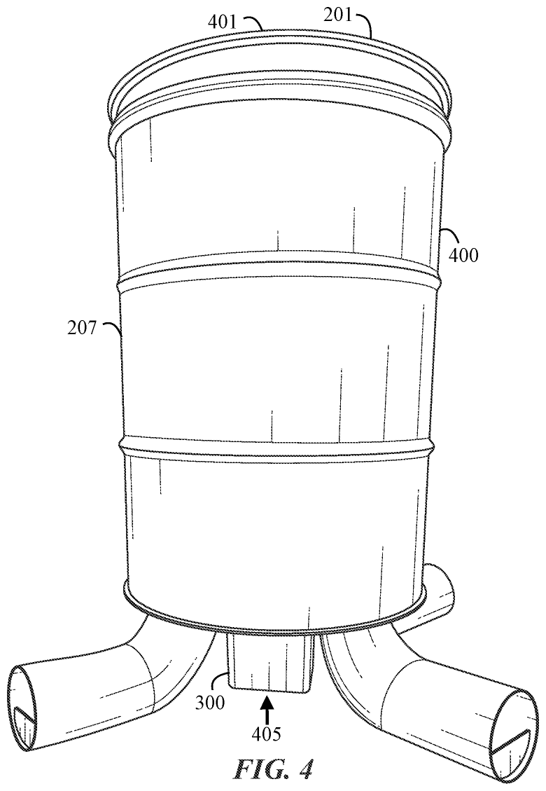

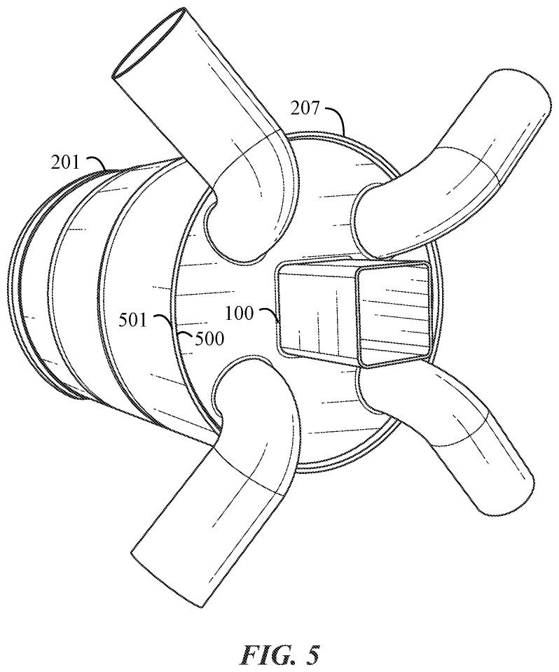

FIG. 4 illustrates a perspective view of the livestock feeder 201, hopper 207, and egress ports in an in-use configuration. The hopper 207 may be configured as a barrel 400 having a hollow interior 401 wherein feed is disposed. A lid 401 is provided to enclose the interior 401 to protect from unwanted access to the feed. The mount 300 receives a post (shown as arrow 405) such that the livestock feeder 201 is raised above the ground via the single post. Gravity allows for the flow of feed from the hopper 207 through each port to provide a passive and automatic flow of feed to the livestock. FIG. 5 illustrates a perspective view of the bottom side 200 of the livestock feeder 201. The base 100 includes an outer perimeter 500 which corresponds to a rim 501 of the hopper 207 to form a hermetic seal, thus retaining feed within the interior of the hopper 207. The base 100 is removable to allow servicing, cleaning, and replacement of various components.

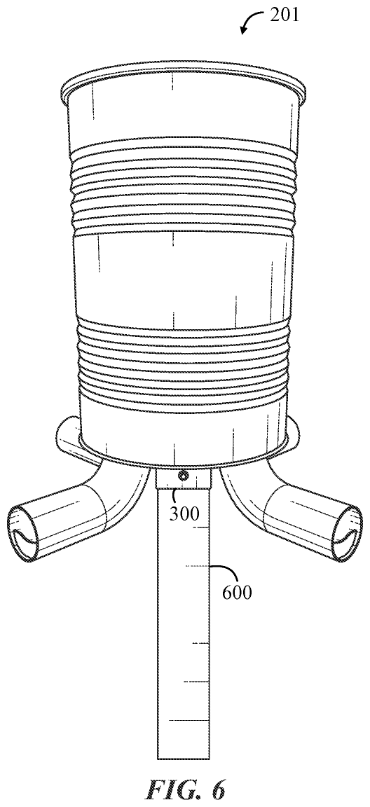

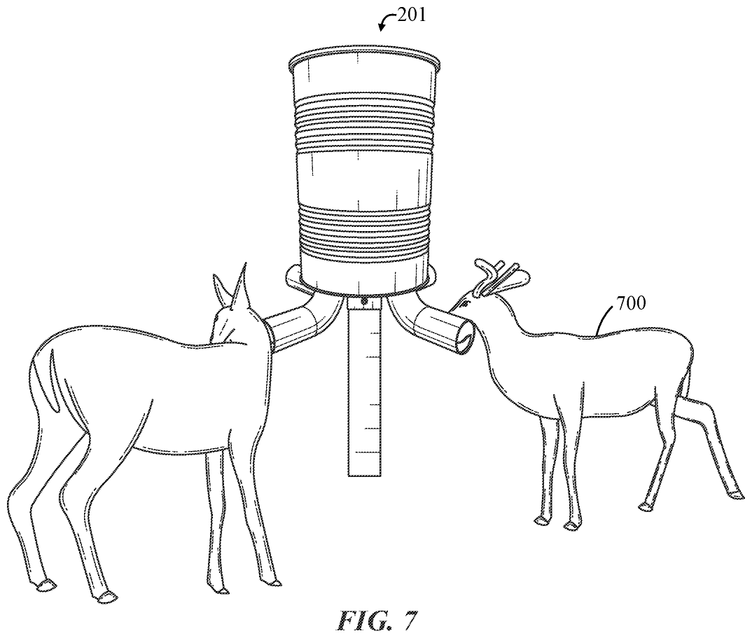

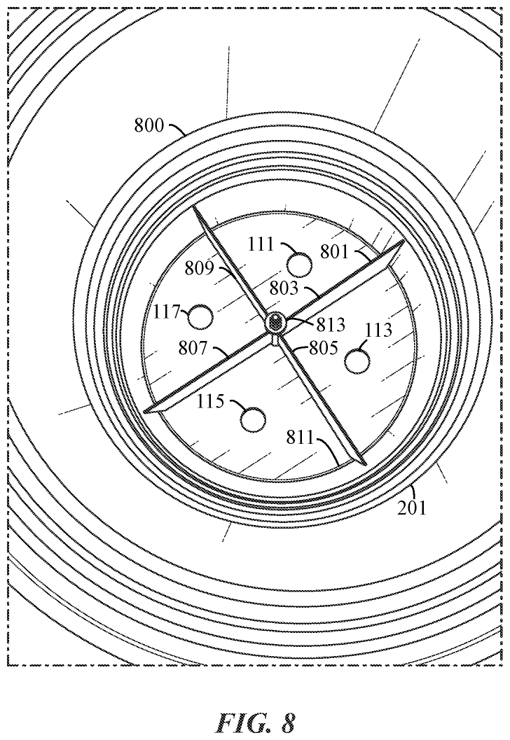

FIG. 6 illustrates a front elevation view of the livestock feeder 201 mounted to a post 600 via the mount 300. The post 600 is insertable into the mount 300 and raises the livestock feeder 201 above the ground. The mount 300 may be fastened to the post 600 using bolts, or other known fasteners. FIG. 7 illustrates a front elevation view of the livestock feeder 201 and livestock 700 feeding from the livestock feeder.

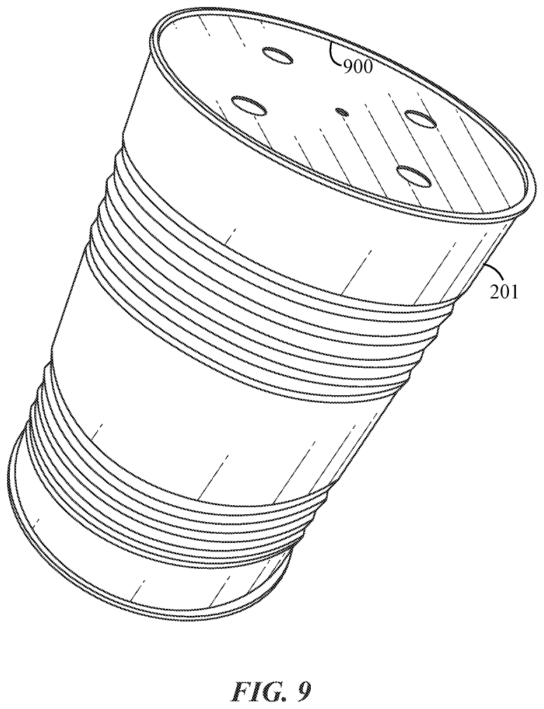

FIG. 8 illustrates a cutaway view of the interior 800 of the hopper 201 including the divider 801. The divider 801 includes a plurality of wings 803, 805, 807, 809 which provide even feed distribution through each aperture 111, 113, 115, 117. The divider 801 slides through the interior 800 of the hopper 201 and over the fastener 119 to tightened thereto to retain the divider 801 at the bottom surface 811 of the hopper 201. The fastener 119 includes a washer and bolt 813 to tighten the divider 801 at the bottom surface 811.

In some embodiments, the divider 801 couples the base 100 to the bottom of the hopper 201, via the fastener 119. In such, the hopper 201 (i.e., the barrel) can be readily used with the base 100 without having to weld or otherwise permanently attach the base 100 to the hopper 201. This allows for any barrel to be used as a hopper 201, while only having to provide the four apertures 111, 113, 115, 117 at the bottom of the barrel which should properly algin with the ports 103, 105, 107, 109. FIG. 9 illustrates a perspective view of the bottom side 900 of the hopper 201.

One skilled in the arts will readily understand that the hopper 207 may be provided having various sizes, dimensions, and configurations.

In some embodiments, the livestock feeder is constructed of steel, or similar rigid and tamper resistant material to prevent damage from opportunist animals. The livestock feeder 201 is also capable of withstanding prolonged exposure to the elements and is capable of repeated use.

In some embodiments, each port 103, 105, 107, 109 is about 2-inches in diameter to provide sufficient flow of feed therethrough.

In some embodiments, the base 100 is constructed having a 22-inch diameter and is about 3/16-inch thick.

In some embodiments, bottom side of the 22 inch plate has (4) (5 inch tube) 8″×15″ 90 degree elbow steel pipe welded under each 2 inch cut out hole for dispersing feed. The inside collar is a ¾″ 8 inch long square steel tube with 4 welded wings 3/16″ thick 8″×7¾″×10⅜″. The inside inserted wing collars not only secures the bottom part of the livestock feeder, to the bottom of the drum/barrel it also allows for equal portions of feed to be dispersed to each of the cut out apertures in the bottom of the hopper.

In some embodiments, the livestock feeder transforms a drum/barrel into a four port gravity feeder with holes cut out of bottom of barrel with one center hole cut out and only needs one leg to hold drum/barrel off ground.

Some dynamic elements may be finely tuned and reactive to change with minimal temperature or other changes, while other elements may be less susceptible to change and require greater change to exhibit their dynamic elements.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A livestock feeder, comprising:
a hopper including an interior to store feed;
a base removably coupled to a bottom of the hopper, the base comprising a plurality of apertures each opening to a port to dispense the feed via gravity; and
a mount centrally positioned on the base to receive a post, the mount to raise the livestock feeder above the ground.

2. The livestock feeder of claim 1, comprising four ports.

3. The livestock feeder of claim 2, wherein each of the four ports are equally and radially spaced about the base.

4. The livestock feeder of claim 1, wherein each port includes a vertical portion and a curved portion to dispense food away from underneath the livestock feeder.

5. The livestock feeder of claim 1, wherein the base is coupled to the hopper via a fastener.

6. The livestock feeder of claim 5, wherein the fastener extends through the base and through the interior of the hopper to releasably couple the base to the hopper.

7. The livestock feeder of claim 1, wherein the hopper is configured as a barrel.

8. The livestock feeder of claim 7, wherein the hopper is further comprised of a lid to enclose the interior of the hopper.

9. A livestock feeder, comprising:
a hopper including an interior to store feed, the feed disposable within the interior of the hopper via a user;
a circular base removably coupled to a bottom of the hopper, the base including a perimeter complimentary to a rim of the hopper to form a hermetic seal therebetween, the base comprising a plurality of apertures each opening to a port to dispense the feed via gravity; and
a mount centrally positioned on the base to receive a post extending to a ground surface, the mount to raise the livestock feeder above the ground, the livestock feeder to protect the feed from animals and damage from elements.

10. The livestock feeder of claim 9, comprising four ports.

11. The livestock feeder of claim 10, wherein each of the four ports are equally and radially spaced about the base.

12. The livestock feeder of claim 11, wherein each port include a vertical portion and a curved portion to dispense food away from underneath the livestock feeder.

13. The livestock feeder of claim 12, wherein the base is coupled to the hopper via a fastener.

14. The livestock feeder of claim 13, wherein the fastener extends through the base and through the interior of the hopper to releasably couple the base to the hopper.

15. The livestock feeder of claim 14, wherein the hopper is configured as a barrel.

16. The livestock feeder of claim 15, wherein the hopper is further comprised of a lid to enclose the interior of the hopper.

17. The livestock feeder of claim 16, wherein the barrel is constructed of steel.

18. The livestock feeder of claim 17, wherein each of the plurality of ports is constructed of metal.
